(19) United States
(12) Patent Application Publication
(10) Pub. No.: US 2025/0118063 A1
(43) Pub. Date: Apr. 10, 2025

(54) AUTOMATIC ISSUE DETECTION IN MODELS

(71) Applicant: NEC Laboratories America, Inc., Princeton, NJ (US)

(72) Inventors: Jong-Chyi Su, San Francisco, CA (US); Samuel Schulter, Long Island City, NY (US); Sparsh Garg, Fremont, CA (US); Manmohan Chandraker, Santa Clara, CA (US); Mingfu Liang, Evanston, IL (US)

(21) Appl. No.: 18/891,625

(22) Filed: Sep. 20, 2024

Related U.S. Application Data
(60) Provisional application No. 63/542,382, filed on Oct. 4, 2023.
(60) Provisional application No. 63/542,397, filed on Oct. 4, 2023.

(51) Int. Cl. G06V 10/82; G06V 10/75; G06V 20/70

(52) U.S. Cl. CPC G06V 10/82; G06V 10/75; G06V 20/70

(57) ABSTRACT

Systems and methods include detecting one or more objects in an image and generating one or more captions for the image. One or more predicted categories of the one or more objects detected in the image and the one or more captions are matched. From the one or more predicted categories, a category that is not successfully predicted in the image is identified. Data is curated to improve the category that is not successfully predicted in the image. A perception model is finetuned using data curated.

### RELATED APPLICATION INFORMATION

This application claims priority to U.S. Provisional Patent Application No. 63/542,382 filed on Oct. 4, 2023, incorporated herein by reference in its entirety. This application claims priority to U.S. Provisional Patent Application No. 63/542,397 filed on Oct. 4, 2023, incorporated herein by reference in its entirety.

This application is related to U.S. Patent Application Ser. No. TBD (Attorney docket number 23054) entitled “AUTOMATIC DATA SYSTEMS FOR NOVEL OBJECT DETECTION”, filed currently herewith.

### BACKGROUND

### Technical Field

The present invention relates to artificial intelligence (AI) systems, and more particularly, to systems and methods for automatically detecting issues or weaknesses in models.

### Description of the Related Art

Training robust perception models is challenging since a large amount of annotated data is needed. Detecting rare objects is difficult due to limited data annotations. This challenge is particularly critical in applications such as, e.g., autonomous driving, as vehicles encounter various rare events on the road, and false negative predictions can lead to serious accidents.

A typical solution to this challenge is to have humans identify rare or unseen categories that the perception model fails to predict correctly, and then collect more data and labels for these categories to enhance robustness. However, this process necessitates experts actively monitoring the model's performance. Collecting human annotations is expensive and inefficient, but remains an important part of training autonomous driving systems. In particular, obtaining annotations for novel objects is even more important, as models are often unfamiliar with such objects, which can lead to failures.

### SUMMARY

According to an aspect of the present invention, systems and methods include detecting one or more objects in an image and generating one or more captions for the image. One or more predicted categories of the one or more objects detected in the image and the one or more captions are matched. From the one or more predicted categories, a category that is not successfully predicted in the image is identified. Data is curated to improve the category that is not successfully predicted in the image. A perception model is finetuned using data curated.

According to another aspect of the present invention, a computer-implemented method for identifying novel objects in an image includes detecting objects in an image and generating captions for the image using a visual language model (VLM). Predictions are matched between the objects detected in the image and the captions to identify categories of novel objects in the image. Image features and text description features are generated using descriptions of the novel objects using the VLM. Relevant images are selected as candidates using similarity scores calculated between the image features and the text description features. A model is updated using the relevant images and associated descriptions of the novel objects.

According to another aspect of the present invention, a system includes a hardware processor; and a memory that stores a computer program which, when executed by the hardware processor, causes the hardware processor to: detect one or more objects in an image; generate one or more captions for the image; match one or more predicted categories of the one or more objects detected in the image and the one or more captions; identify, from the one or more predicted categories, a category that is not successfully predicted in the image; curate data to improve the category that is not successfully predicted in the image; and finetune a perception model using data curated.

According to another aspect of the present invention, a computer program product for finding areas for improvement in a perception model, the computer program product comprising a computer readable storage medium storing program instructions embodied therewith, the program instructions executable by a hardware processor to cause the hardware processor to: detect one or more objects in an image; generate one or more captions for the image; match one or more predicted categories of the one or more objects detected in the image and the one or more captions; identify, from the one or more predicted categories, a category that is not successfully predicted in the image; curate data to improve the category that is not successfully predicted in the image; and finetune a perception model using data curated.

According to another aspect of the present invention, a computer-implemented method for finding areas for improvement in a perception model includes detecting objects in an image and generating captions for the image using a visual language model (VLM). Predictions are matched between the objects detected in the image and the captions. Categories that have not been successfully predicted in the image are identified. Data is curated to improve the categories that have not been successfully predicted in the image. The perception model is finetuned using the data curated to enhance accuracy in predicting objects in the categories.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high level system/method with a novel issue finder and data feeder for detecting novel objects, in accordance with an embodiment of the present invention;

FIG. 2 is a block/flow diagram illustrating the system/method of FIG. 1 in greater detail, in accordance with an embodiment of the present invention;

FIG. 3 is a block/flow diagram illustrating a system/method showing greater detail for the novel issue finder, in accordance with an embodiment of the present invention;

FIG. 4 is a block diagram illustrating a system for detecting issues with a perception model and for detecting novel objects, in accordance with an embodiment of the present invention;

FIG. 5 is a flow diagram illustrating a method for detecting novel objects, in accordance with an embodiment of the present invention;

FIG. 6 is a flow diagram illustrating a method for determining areas for improvement in a perception model (issue finder), in accordance with an embodiment of the present invention; and

FIG. 7 is a schematic diagram showing an autonomous vehicle system which detects novel objects and improves perception models using the issue finder, in accordance with an embodiment of the present invention.

### DETAILED DESCRIPTION OF PREFERRED EMBODIMENTS

In accordance with embodiments of the present invention, systems and methods are described that provide automatic identification of novel objects in a query or input. In an embodiment, a data system includes an image processing system, such as a machine vison system, an autonomous driving system or any other data system that experience new/novel objects. An automatic issue identifier can be employed to identify issues with a perception model without human intervention, thereby achieving greater efficiency in a data system.

In accordance with embodiments of the present invention, systems and methods automatically label data efficiently and efficiently query and label novel objects from a large pool of unlabeled data, without incurring any human labeling costs. To achieve this, a data system has been developed that is capable of automatically identifying rare or novel objects, querying the data, and auto-labeling the data for model training. An automatic issue finder is provided for perception models that includes a pipeline that leverages vision-language models (VLMs). A dense captioning model is employed to generate detailed descriptions of an image and identify potential objects in a scene. Predictions of the perception model are matched with these descriptions. After identifying novel categories that do not exist in the model's label space, as well as those categories that the model predicts inaccurately, additional data is curated for the novel objects to further fine-tune and improve the model.

Novel objects can be identified by comparing an output between the dense captioning model and an object detector. To efficiently query data that may contain novel objects, VLMs are leveraged that are pre-trained on a vast number of image and text pairs to identify candidate images. For each image, auto-labeling is performed. In this process, region proposals are generated and then pseudo-labels are created for each bounding box in the image. The model is re-trained using these pseudo-labels, enabling the model to recognize novel objects. Self-training is employed to iteratively enhance the model's performance.

By leveraging large vision-language models (VLM) to automate the data system, existing data and label collecting pipelines that rely on human annotations, which are expensive and inefficient, can be avoided. The present invention does not require any human annotations; instead, the model can automatically learn to predict novel objects. The present invention leverages the dense captioning model to identify missing objects in the predictions. Instead of only using the model's predictions, the VLMs are employed to identify potential images that contain novel objects, reducing the number of images for which pseudo-labels need to be generated. The present invention combines the pseudo-labeling with continual training for novel categories and further improves the model using self-training, which is distinguished from existing methods.

By leveraging VLMs to identify potential objects in the scene and then matching the model's predictions, human intervention to identify model inaccuracies is reduced or eliminated, making embodiments of the present invention more efficient and robust. With the present embodiments, potential issues and rare objects can be easily identified, enabling the model to dynamically improve.

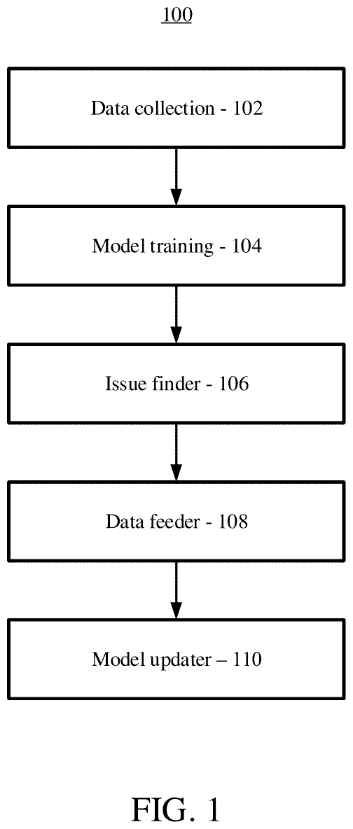

Referring now in detail to the figures in which like-numerals represent the same or similar elements and initially to FIG. 1, a system 100 for detecting novel objects in a computer environment is described and shown in accordance with embodiments of the present invention. In block 102, data is collected to be processed. The data can include images or other data sources. The data can include objects, including novel objects that may not be easily identifiable. As an example, data can include an image or images of a street scene, where pedestrians, cars, street signs, etc. are anticipated to be present; however, the scene can include a novel object or objects, e.g., a mattress within the roadway, or other novel object.

After collecting the data, model training occurs in block 104 using the data collected. The model training includes training an initial perception model. The perception model can include sensor fusion data, which merges data from at least two sensors. Perception refers to the processing and interpretation of sensor data to detect, identify, track and classify objects. Sensor fusion and perception enable, e.g., an automated driver assistance system (ADAS) to develop a 2D or 3D model of the surrounding environment that feeds into a control unit for a vehicle. Other applications can include inspection machines in a manufacturing environment, computer vision, cyber security applications, etc. The perception model can also include bird's eye view (BEV) perspectives as trajectory predictions. Trajectory prediction includes information for predicting short-term (1-3 seconds) and long-term (3-5 seconds) spatial coordinates of various vehicles or objects, e.g., cars, pedestrians, etc.

In block 106, an issue finder identifies inaccuracies in the data collected, and novel objects are discovered that were not predicted. In block 108, using the descriptions of these novel objects, a data feeder proceeds to query images that may include the same or similar objects from the entire dataset. In block 110, pseudo-labels are generated for each candidate image and used to update the perception model. A final model will have the capability to predict novel objects, and the entire data system operates without the need of human labeling or effort.

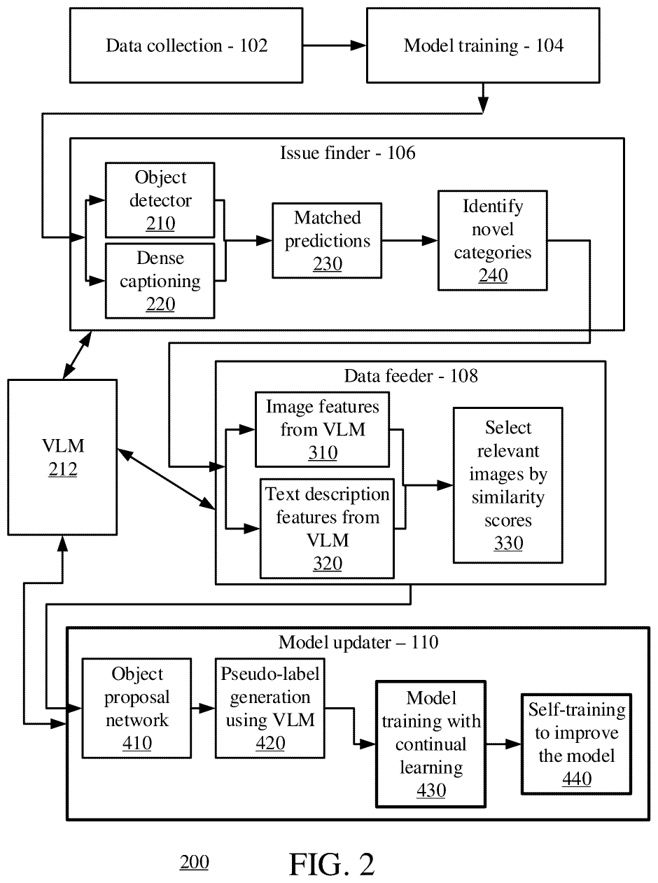

Referring to FIG. 2, a more detailed system 200 for detecting novel objects in a computer environment is described and shown in accordance with embodiments of the present invention. The issue finder, in block 106, obtains predictions from an object detector 210 and generates dense captions 220 using visual language models (VLMs) 212 (e.g., BLIP-2), CLIP, OWL-ViT, etc.) for the input image.

The object detector 210 detects objects in an image. The detector 210 employs a detector model or models to identify objects and then segments the objects and places a bounding box around the objects. The dense captions 220 include verbal descriptions of the image and the objects within the image. For example, for a street scene with construction vehicles, the object detector 210 would detect the construction vehicles in the image while the dense captioning 220 would describe the scene, e.g., “The image shows a street scene with several construction vehicles parked on the side of the road. There are two trucks visible, one on the left side and the other on the right side. In addition to the trucks, there is also a car parked near the center of the scene . . . ”.

The VLM 212 can be queried using e.g., free-form text descriptions of the novel object. For example, Text: An image containing a <novel object>, <object description>”. Using a large set of unlabeled images in the VLM, e.g., a zero-shot classification or other classification method can be employed to generate a smaller set of relevant images.

In block 230, predicted categories are matched or compared and captions are added to identify missing predictions. In block 240, a list of novel categories are generated that do not exist in the label space of the current model. For each novel category, the aim is to query images that could contain the novel object to reduce the number of candidates, thereby increasing the efficiency of the model update. The data feeder, in block 108, is employed to achieve this. The VLM 212 is used to generate image features in block 310, and text features using descriptions of the novel objects in block 320. Next, in block 330, a similarity score is calculated between the image and text features to select relevant images as candidates. The relevant images are images that potentially include the novel object or objects. These can be determined by computing a similarity score between the VLM images and the novel objects in question. In this way, the data feeder can significantly reduce a number of objects that need to be pseudo-labeled in the model updater in block 110. This improves the use of computational resources and speed of the processing.

The perception model is updated by the model updater in block 110. For each candidate image, an object proposal network is run to obtain bounding boxes for each object in the image in block 410. An object or region proposal network (RPN) is a fully convolutional network that predicts object bounds and object scores at each spatial position. This preprocessing technique is employed in object detection to guide the search for objects. For each bounding box, pseudo-labels are generated using the VLM 212 again by comparing the features of a cropped image and text description in block 420. All the pseudo-labels are utilized, whether the pseudo-labels pertain to novel or known categories, to train the model in block 430 (continual learning).

A pseudo-label is a predicted label for unlabeled data that is added to training data to improve the performance of a model. The pseudo-labeling provides clues for identifying the novel objects. As the model is refined, the novel objects are more confidently identified using an overall contextual approach. This means that all objects in a scene provide some information about the other objects in the scene. Over time considering all of the objects, the model is improved by leveraging context of a scene and associated objects therein.

The model is further enhanced by applying self-training to achieve the self-improvement in block 440. Self-training can include repeating the process from the data collection stage through the model update stage. Each iteration will improve the model by identifying additional novel objects and doing so with greater confidence.

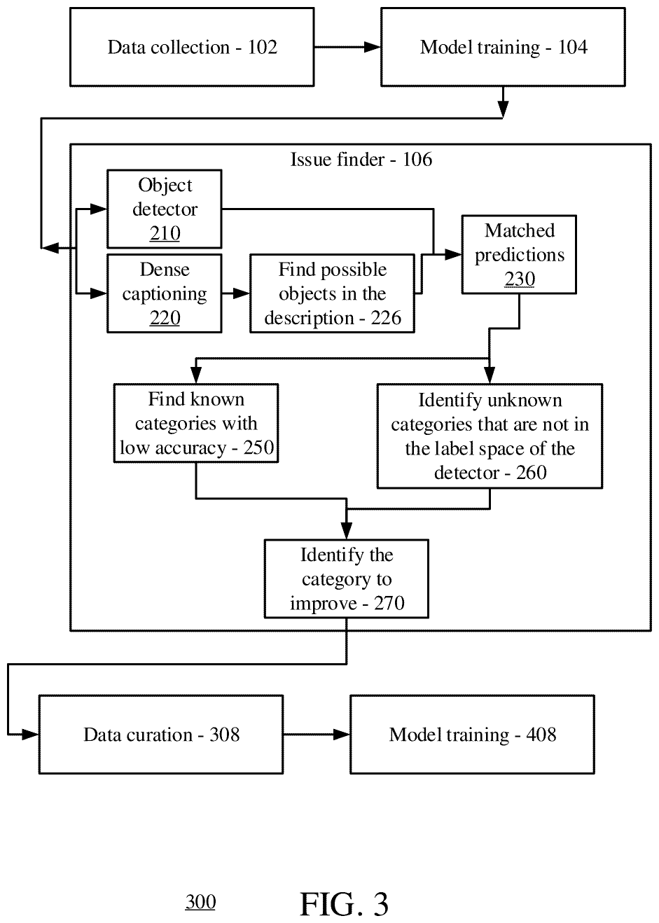

Referring to FIG. 3, another embodiment includes further details of the issue finder in block 106 in accordance with embodiments of the present invention. After collecting data in block 102 and training the initial perception model in block 104, the issue finder in block 106 identifies inaccuracies and novel objects that need improvement. The issue finder automates the identification of these issues. An issue finder in accordance with embodiments of the present invention, finds areas of a model that need to be improved. For example, a model may be proficient in identifying passenger vehicles but not construction vehicles. The issue finder finds objects that are not identified easily, novel or provide difficulty for the model. The issue finder can employ historic data, current similarity scores or any other criteria to identify issues with a model.

Once the categories that need improvement are identified. Data can be curated, in block 308, based on the collected data. Then, the curated data can be employed to finetune the model (model training) in block 408 to enhance its performance. One aspect of the present invention lies in the issue finder (300). Curated data can include data similar to the issues identified. For example, construction vehicle images can be employed and dense captions related thereto.

The issue finder, in block 106, detects objects with object detector 210 and generates dense captions 220 of the image using VLMs (212, FIG. 2) pretrained on large image-text pairs. These dense captions describe the scenes in detail. For example, the scene may include a police car driving on duty, alongside many cars and trucks on a crowded highway.

Next, potential objects are identified in the descriptions in block 226, and matches are established, in block 230, with the predictions from the object detector 210. In block 250, the categories that exist within the label space of the object detector but were not successfully predicted are identified. Additionally, unknown categories that the model has not been trained on are also pinpointed in block 260. By combining these categories, the areas where the model needs improvement can be identified in block 270. Subsequently, in block 308 and 408, additional data can be curated for these categories and the model fine-tuned to enhance its accuracy in predicting them.

Artificial Machine learning systems can be used to predict outputs or outcomes based on input data, e.g., image data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

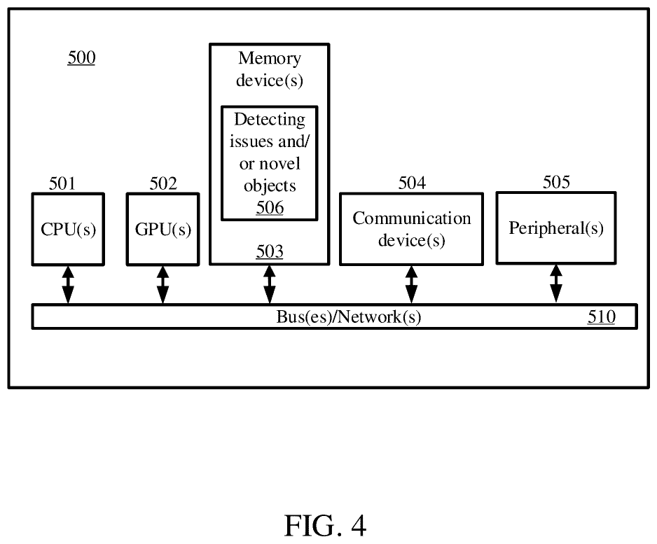

Referring to FIG. 4, a block diagram is shown for an exemplary processing system 500, in accordance with an embodiment of the present invention. The processing system 500 includes a set of processing units (e.g., CPUs) 501, a set of GPUs 502, a set of memory devices 503, a set of communication devices 504, and a set of peripherals 505. The CPUs 501 can be single or multi-core CPUs. The GPUs 502 can be single or multi-core GPUs. The one or more memory devices 503 can include caches, RAMs, ROMs, and other memories (flash, optical, magnetic, etc.). The communication devices 504 can include wireless and/or wired communication devices (e.g., network (e.g., WIFI, etc.) adapters, etc.). The peripherals 505 can include a display device, a user input device, a printer, an imaging device, and so forth. Elements of processing system 500 are connected by one or more buses or networks (collectively denoted by the figure reference numeral 510).

In an embodiment, memory devices 503 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 503 store program code for implementing one or more functions of the systems and methods described herein for detecting issues and novel objects (e.g., programmed software 506 for detecting issues and novel objects). The memory devices 503 can store program code for implementing one or more functions of the systems and methods described herein.

Of course, the processing system 500 may also include other elements (not shown), as readily contemplated by one of skill in the art, as well as omitting certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 500.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

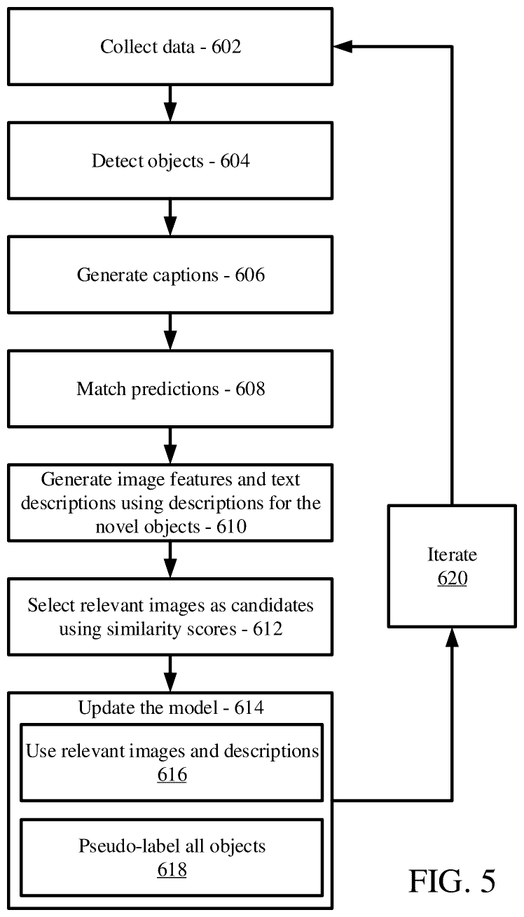

Referring to FIG. 5, a computer-implemented method for detecting novel objects in a scene or image. In block 602, data is collected. This can include gathering image data in any application, and in particular in, e.g., an autonomous driving vehicle. The vehicle can include cameras, LiDAR, ultrasound or another other sensor or sensors that gather information during vehicle operation. In the images collected, an object detector detects objects in the image or images in block 604. In addition, captions are generated for the image(s) using a visual language model (VLM) in block 606. The captions generated are preferably dense and can be generated from unlabeled data of the VLM.

In block 608, matching predictions are generated by the model between the objects detected in the image and the captions to identify categories of novel objects in the image. These categories can be created based on any object that cannot be identified with a confidence above a threshold value set for the task. In block 610, image features and text description features are generated using descriptions of the novel objects using the VLM.

In block 612, relevant images are selected as candidates using similarity scores calculated between the image features and the text description features. By identifying images in the VLM that include potential novel objects, a number of images can be reduced that would otherwise need pseudo-labeling in future steps. In block 614, the model is updated using the relevant images and associated descriptions of the novel objects. In block 616, an object proposal network can be run to obtain bounding boxes for each object in the image. In block 618, pseudo-labeling each object in the bounding boxes using the VLM can be performed. The pseudo-labeling is performed on all found objects in the image so that confidence in identifying novel objects can be increased by basing the identification on context of all the objects.

The model can be updated by self-training and does not need human intervention for the training. Over time the model improves by identifying novel objects constantly increasing the object vocabulary of the model.

In block 620, iterations of collecting data through updating the model are performed to refine the model converging on higher confidences of novel objects with each iteration.

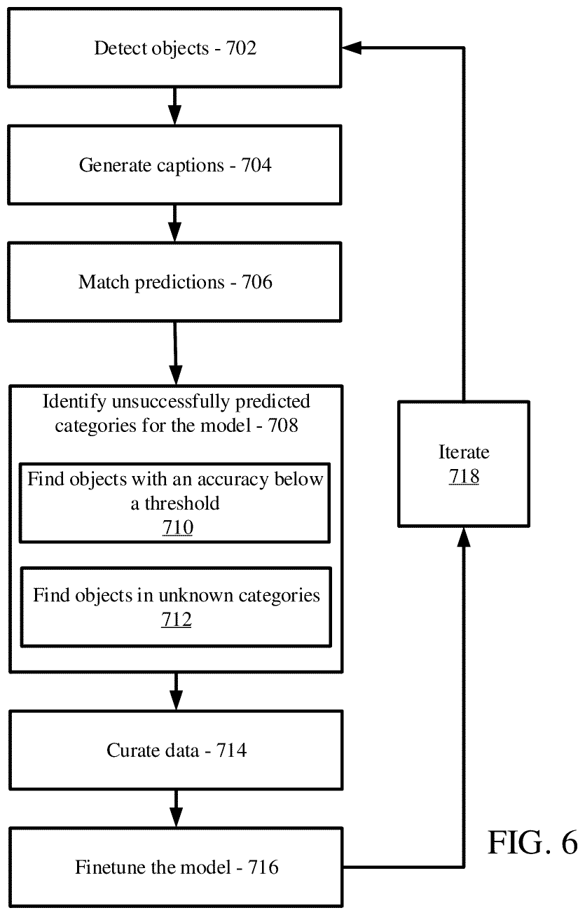

Referring to FIG. 6, other methods for finding areas for improvement in a perception model are described and shown. An issue finder is implemented to discovery issues, holes or weaknesses in the model. The issue finding can work autonomously and be introduced into any system and run in the background to improve a model, such as a perception model, over time. In block 702, objects are detected in an image. This can include detecting the objects in the image by employing an object detector having a label space. In block 704, captions for the image are generated using a VLM. The VLM includes unlabeled data. In block 706, predictions are matched between the objects detected in the image and the captions.

In block 708, categories that have not been successfully predicted in the image are identified. This can include, e.g., finding objects in known categories with accuracy below a threshold in block 710 and/or finding objects in unknown categories outside the label space of the object detector in block 712. The threshold can be set to designate acceptable similarity scores (e.g., 80%) that the model can accurately identify an object, e.g., in an image.

In block 714, data can be curated to improve the categories that have not been successfully predicted in the image. This can include images and text to further strengthen the model on the identified categories for which the model is lacking. In block 716, the perception model is finetuned using the data curated to enhance accuracy in predicting objects in the categories. This can include employing self-training. The model can also be improved by iterating to refine the perception model in block 718.

In one example, the issue finder in accordance with the present embodiments can be implemented by an autonomous driving vehicle or other system that employs computer vision to dynamically monitor the model for weaknesses and work to improve them.

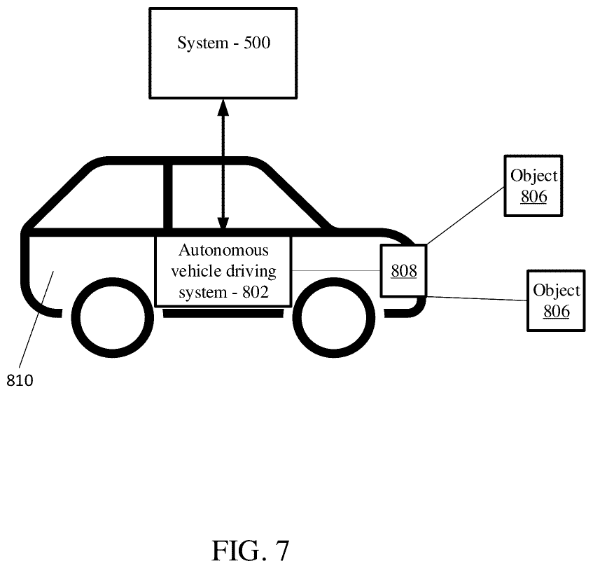

Referring to FIG. 7 with reference to FIG. 4, embodiments of the present invention can be employed in any number of practical applications. A self-training system that discovers and identifies novel objects can be employed in any computer vision scenario. A self-training system that discovers weaknesses in a perception model can also be employed in any computer vision scenario. These systems can be employed in autonomous driving applications as well. In an embodiment, a vehicle 810 can include an autonomous driving system 802 (e.g., Advanced Driving Assistance System (ADAS)). The autonomous driving system 802 includes one or more sensors 808 that are configured to perceive objects 806 with which the vehicle 810 will encounter. The autonomous driving system 802 can employ computer vision to detect the objects and respond by avoiding them.

The autonomous driving system 802 can interact with or be a part of system 500, which includes software 506 (FIG. 4). Software 506 can detect novel objects and can update a perception model by providing an identity for novel objects. Software 506 can also determine weaknesses in the perception model by using as feedback any unknown objects and/or objects that cannot be identified with sufficient accuracy. Software 506 can be distributed or can exist on the vehicle 810 or remotely from the vehicle 810 and be accessible over a network, such as, e.g., the Cloud/internet, etc.

Since the system 500 is self-training, the system 500 can be employed concurrently with other functions of the autonomous driving system 802. For example, while avoiding objects 806, the system 500 can be learning at the same time to categorize and identify novel objects. In addition, perception models can be improved by using the novel objects to determine any deficiencies in the models' ability to correctly predict objects. As time passes, the model improves and can adapt to new environments.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
detecting one or more objects in an image;
generating one or more captions for the image;
matching one or more predicted categories of the one or more objects detected in the image and the one or more captions;
identifying, from the one or more predicted categories, a category that is not successfully predicted in the image;
curating data to improve the category that is not successfully predicted in the image; and
finetuning a perception model using data curated.

2. The method of claim 1, further comprising iterating to refine the perception model.

3. The method of claim 1, wherein identifying the category includes finding objects in known categories with accuracy below a threshold.

4. The method of claim 1, wherein detecting the one or more objects in the image includes employing an object detector having a label space.

5. The method of claim 4, wherein identifying the category includes finding objects in unknown categories outside the label space of the object detector.

6. The method of claim 1, wherein generating the one or more captions includes generating the one or more captions for the image using a visual language model (VLM).

7. The method of claim 1, wherein finetuning the perception model includes self-training.

8. The method of claim 1, wherein the method is implemented by an autonomous driving vehicle.

9. A system, comprising:
a hardware processor; and
a memory that stores a computer program which, when executed by the hardware processor, causes the hardware processor to:
detect one or more objects in an image;
generate one or more captions for the image;
match one or more predicted categories of the one or more objects detected in the image and the one or more captions;
identify, from the one or more predicted categories, a category that is not successfully predicted in the image;
curate data to improve the category that is not successfully predicted in the image; and
finetune a perception model using data curated.

10. The system of claim 9, wherein the computer program further causes the hardware processor to iterate to refine the perception model.

11. The system of claim 9, wherein the computer program further causes the hardware processor to identify the category that is not successfully predicted in the image by finding objects in known categories with accuracy below a threshold.

12. The system of claim 9, wherein the computer program further causes the hardware processor to detect the one or more objects in the image by employing an object detector having a label space.

13. The system of claim 12, wherein the computer program further causes the hardware processor to identify the category that is not successfully predicted in the image by finding objects in unknown categories outside the label space of the object detector.

14. The system of claim 9, wherein the computer program further causes the hardware processor to generate captions for the image using unlabeled data from a visual language model (VLM).

15. The system of claim 9, wherein the perception model is finetuned by self-training.

16. The system of claim 9, wherein the system is included in an autonomous driving vehicle.

17. A computer program product, the computer program product comprising a computer readable storage medium storing program instructions embodied therewith, the program instructions executable by a hardware processor to cause the hardware processor to:
detect one or more objects in an image;
generate one or more captions for the image;
match one or more predicted categories of the one or more objects detected in the image and the one or more captions;
identify, from the one or more predicted categories, a category that is not successfully predicted in the image;
curate data to improve the category that is not successfully predicted in the image; and
finetune a perception model using data curated.

18. The computer program product of claim 17, wherein the computer program product further causes the hardware processor to identify the category that is not successfully predicted in the image by finding objects in known categories with accuracy below a threshold.

19. The computer program product of claim 17, wherein the computer program product further causes the hardware processor to:
detect the one or more objects in the image by employing an object detector having a label space; and
identify categories that have not been successfully predicted in the image by finding objects in unknown categories outside the label space of the object detector.

20. The computer program product of claim 17, wherein the perception model is finetuned by self-training on board an autonomous driving vehicle.
